(19) United States
(12) Patent Application Publication
(10) Pub. No.: US 2017/0122418 A1
(43) Pub. Date: May 4, 2017

(54) FOUR MODE POWERTRAIN CONFIGURATIONS WITH A BALL VARIATOR CONTINUOUSLY VARIABLE TRANSMISSION USED AS A POWERSPLIT

(71) Applicant: Dana Limited, Maumee, OH (US)

(72) Inventor: Raymond J. HAKA, Brighton, MI (US)

(21) Appl. No.: 15/284,940

(22) Filed: Oct. 4, 2016

Related U.S. Application Data
(60) Provisional application No. 62/250,588, filed on Nov. 4, 2015.

(51) Int. Cl. F16H 37/02; F16H 3/66; F16H 15/50

(52) U.S. Cl. CPC F16H 37/021; F16H 15/503; F16H 3/66; F16H 2200/0043; F16H 2200/2007; F16H 2200/2041; F16H 2037/023

(57) ABSTRACT

Devices and methods are provided herein for the transmission of power in motor vehicles. Power is transmitted in a smoother and more efficient manner by splitting torque into two or more torque paths. A continuously variable transmission is provided with a ball variator assembly, a planetary gearset coupled thereto and an arrangement of rotatable shafts with multiple gears and clutches that extend the ratio range of the variator. In some embodiments, clutches are coupled to the gear sets to enable synchronous shifting of gear modes.

### CROSS-REFERENCE

The present application claims priority to U.S. Provisional Patent Application No. 62/250,588, filed Nov. 4, 2015, which is incorporated herein by reference in its entirety.

### BACKGROUND OF THE INVENTION

A driveline including a continuously variable transmission allows an operator or a control system to vary a drive ratio in a stepless manner, permitting a power source to operate at its most advantageous rotational speed.

### SUMMARY OF THE INVENTION

Provided herein is a continuously variable transmission comprising: a first rotatable shaft operably coupleable to a source of rotational power; a second rotatable shaft aligned substantially coaxial to the first rotatable shaft, the first rotatable shaft and second rotatable shaft forming a main axis of the transmission; a third rotatable shaft aligned substantially parallel to the main axis; a variator assembly having a first traction ring and a second traction ring in contact with a plurality of traction planets, each traction planet having a tiltable axis of rotation; wherein the variator assembly is coaxial with the main axis; a first planetary gearset having a first planet carrier, a first sun gear, and a first ring gear; wherein the first sun gear is coupled to the first traction ring, the first ring gear is coupled to the second traction ring, and the first planet carrier coupled to the first rotatable shaft; a second planetary gear set operably coupled to the third rotatable shaft, the second planetary gear set having a second planet carrier, a second sun gear, and a second ring gear; a first clutch positioned coaxial with the third rotatable shaft; a second clutch coupled to the first clutch, the second clutch coaxial with the third rotatable shaft; a third clutch coaxial with the third rotatable shaft; and a fourth clutch operably coupled to the second planetary gear set.

In some embodiments of the continuously variable transmission, a first-and-fourth mode gear set is operably coupled to the first clutch.

In some embodiments of the continuously variable transmission, a second-and-third mode gear set is operably coupled to the second clutch.

In some embodiments of the continuously variable transmission, the first-and-fourth mode gear set is operably coupled to the first ring gear.

In some embodiments of the continuously variable transmission, the second-and-third mode gear set is operably coupled to the second rotatable shaft.

In some embodiments of the continuously variable transmission, the first clutch is configured to selectively engage the second ring gear.

In some embodiments of the continuously variable transmission, the second clutch is configured to selectively engage the second ring gear.

In some embodiments of the continuously variable transmission, the fourth clutch is operably coupled to the second sun gear and the second ring gear.

In some embodiments of the continuously variable transmission, the second planet carrier is coupled to the third rotatable shaft.

In some embodiments of the continuously variable transmission, a reverse band is operably coupled to the third clutch.

In some embodiments of the continuously variable transmission, a high mode gear set is operably coupled to the third clutch.

In some embodiments of the continuously variable transmission, a torque converter is operably coupled to the first rotatable shaft.

In some embodiments of the continuously variable transmission, a final drive gear is coupled to the second sun gear.

Provided herein is a continuously variable transmission comprising: a first rotatable shaft operably coupleable to a source of rotational power; a second rotatable shaft aligned substantially coaxial to the first rotatable shaft, the first rotatable shaft and second rotatable shaft forming a main axis of the transmission; a third rotatable shaft aligned substantially parallel to the main axis; a variator assembly having a first traction ring and a second traction ring in contact with a plurality of traction planets, each traction planet having a tiltable axis of rotation; wherein the variator assembly is coaxial with the main axis; a first planetary gearset having a first planet carrier, a first sun gear, and a first ring gear; wherein the first sun gear is coupled to the first traction ring, the first ring gear is coupled to the second traction ring, and the first planet carrier coupled to the first rotatable shaft; a second planetary gear set operably coupled to the third rotatable shaft, the second planetary gear set having a second planet carrier, a second sun gear, and a second ring gear; wherein the second ring gear is operably, and selectively, coupled to the second rotatable shaft; and wherein the second planet carrier is coupled to the third rotatable shaft.

In some embodiments of the continuously variable transmission, a first clutch is positioned coaxial with the third rotatable shaft; and a second clutch is coupled to the first clutch, the second clutch coaxial with the third rotatable shaft.

In some embodiments of the continuously variable transmission, a third clutch is coaxial with the third rotatable shaft; and a fourth clutch is operably coupled to the second planetary gear set.

In some embodiments of the continuously variable transmission, a first-and-fourth mode gear set is coupled to the first clutch.

In some embodiments of the continuously variable transmission, a second-and-third mode gear set is coupled to the second clutch.

In some embodiments of the continuously variable transmission, a high mode gear set is coupled to the third clutch.

In some embodiments of the continuously variable transmission, a final drive gear is coupled to the second sun gear.

Provided herein is a method comprising providing a continuously variable transmission of any configuration described herein.

Provided herein is a method comprising providing a vehicle driveline comprising a continuously variable transmission of any configuration described herein.

Provided herein is a method comprising providing a vehicle comprising a continuously variable transmission of any configuration described herein.

In some embodiments, the method includes engaging the reverse band and the first clutch to operate in a reverse mode.

In some embodiments, the method includes engaging the first clutch and the fourth clutch to operate in a first mode.

In some embodiments, the method includes engaging the second clutch and the fourth clutch to operate in a second mode.

In some embodiments, the method includes engaging the second clutch and the third clutch to operate in a third mode.

In some embodiments, the method includes engaging the first clutch and the third clutch to operate in a fourth mode.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is optionally used in the variator of FIG. 1.

FIG. 3 is an illustrative view of different tilt positions of the ball-type variator of FIG. 1.

FIG. 4 is a schematic diagram of a powersplit variator.

FIG. 5 is a schematic diagram of a four-mode powersplit continuously variable transmission.

FIG. 6 is a table depicting a shift schedule that is optionally implemented with the transmission of FIG. 5.

### DETAILED DESCRIPTION OF THE INVENTION

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the invention. Furthermore, embodiments of the invention optionally include several novel features, no single one of which is solely responsible for its desirable attributes or which is essential to practicing the inventions described.

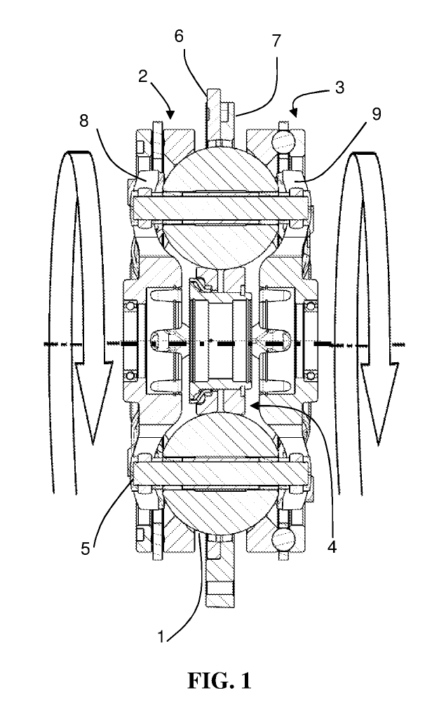

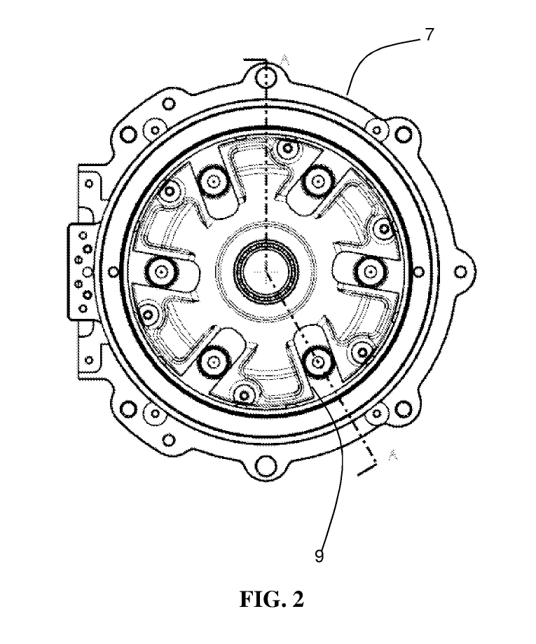

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input traction ring 2 and output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is optionally substantially fixed from rotation while the second carrier member 7 is configured to rotate with respect to the first carrier member, and vice versa. In one embodiment, the first carrier member 6 is provided with a number of radial guide slots 8. The second carrier member 7 is optionally provided with a number of radially offset guide slots 9, as illustrated in FIG. 2. The radial guide slots 8 and the radially offset guide slots 9 are adapted to guide the tiltable axles 5. The axles 5 are optionally adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

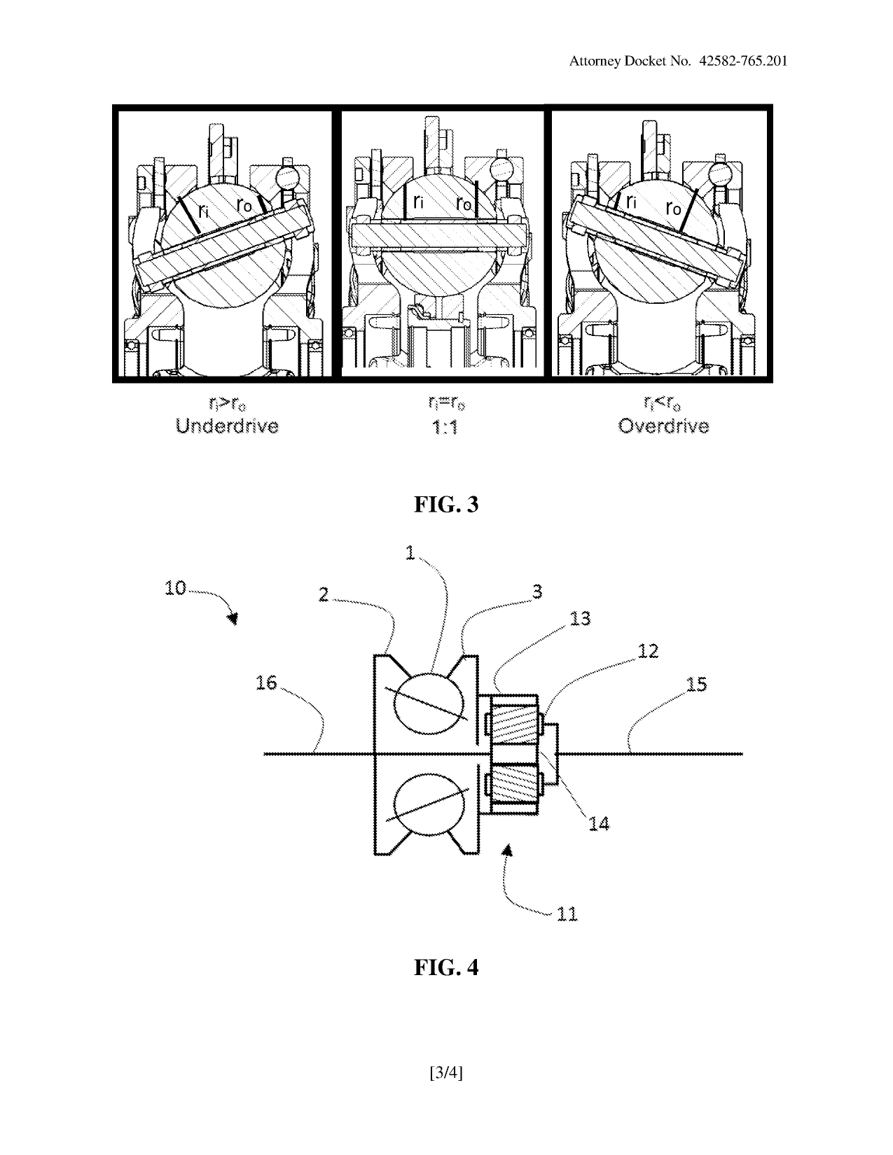

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is optionally changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that is optionally adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling can take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here are capable of operating in both tractive and frictional applications. For example, in the embodiment where a CVT is used for a bicycle application, the CVT is capable of operating at times as a friction drive and at other times as a traction drive, depending on the torque and speed conditions present during operation.

Referring now to FIG. 4, in one embodiment, a powersplit variator 10 includes the balls 1, the first traction ring assembly 2, and the second traction ring assembly 3 operably coupled to a first planetary gear set 11. The first planetary gear set 11 includes a first planet carrier 12 coupled to a first ring gear 13 and coupled to a first sun gear 14. In one embodiment, a first rotatable shaft 15 is coupled to the first planet carrier 12. The first shaft 15 is adapted to transfer rotational power. In one embodiment, the first rotatable shaft 15 is operably coupled to a source of rotational power, such as an internal combustion engine, an electric motor, or other input power coupling device, for example, a torque converter. In one embodiment, the first traction ring assembly 2 is coupled to a second rotatable shaft 16 In one embodiment, the second traction ring assembly 3 is coupled to the first ring gear 13. The first rotatable shaft 15 and the second rotatable shaft 16 are coaxial. The first rotatable shaft 15 and the second rotatable shaft 16 form a main axis, or longitudinal axis, of the powersplit variator 10. It should be noted that various embodiments of transmission configurations presented herein include clutches, shafts, gear sets, and other power transmission couplings adapted to couple to the powersplit variator 10. For description purposes, embodiments disclosed herein include the powersplit variator 10. It should be appreciated, that some embodiments optionally include other configurations of the powersplit variator 10 or the variator depicted in FIG. 1.

Passing now to FIG. 5, in one embodiment, a continuously variable transmission (CVT) 20 has the powersplit variator 10 adapted to receive an input power from a torque converter 21. It should be appreciated that the torque converter 21 is shown as an illustrative example of an input power coupling to the continuously variable transmissions disclosed herein. The CVT 20 includes a third rotatable shaft 22 aligned substantially parallel to the first rotatable shaft 15, or main axis of the CVT 20. The CVT 20 includes a first clutch 23 positioned coaxially with the third rotatable shaft 22. The CVT 20 includes a second clutch 24 positioned coaxially with the third rotatable shaft 22. In one embodiment, the first clutch 23 is coupled to the second clutch 24. The CVT 20 includes a third clutch 25 positioned coaxially with the third rotatable shaft 22. The CVT 20 includes a fourth clutch 26 positioned coaxially with the third rotatable shaft 22. In one embodiment, the first clutch 23, the second clutch 24, the third clutch 25, and the fourth clutch 26 are well-known wet clutches having two positions of engagement. In other embodiments, the first clutch 23, the second clutch 24, the third clutch 25, and the fourth clutch 26 are dry clutches or other typical selective coupling device. In one embodiment, the CVT 20 includes a second planetary gear set 27 having a second sun gear 28, a second planetary carrier 29, and a second ring gear 30. The second planetary gear set 27 is positioned coaxially with the third rotatable shaft 22.

In one embodiment, the first clutch 23 is configured to selectively engage a first-and-fourth mode gear set 31. The first clutch 23 is selectively coupled to the second ring gear 30 of the second planetary gear set 27. The first-and-fourth mode gear set 31 is coupled to the first ring gear 13 of the first planetary gear set 11. The second clutch 24 is configured to selectively engage a second-and-third mode gear set 32. The second clutch 24 is selectively coupled to the second ring gear 30. The second-and-third mode gear set 32 is coupled to the second rotatable shaft 16. The third clutch 25 is configured to selectively engage a high mode gear set 33. The high mode gear set 33 is coupled to the first rotatable shaft 15. In one embodiment, the first clutch 23 and a reverse band 34 are configured to selectively engage a reverse mode of operation. In one embodiment, the reverse band 34 is a steel band configured to wrap around the third clutch 25. Typically, bands used in transmissions are actuated by hydraulic cylinders inside the case of the transmission. The fourth clutch 26 is configured to selectively engage the second ring gear 30. In one embodiment, the CVT 20 includes a final drive gear 35. The final drive gear 35 is operably coupled to the second sun gear 28 of the second planetary gear set 27. The final drive gear 35 is coupled to the fourth clutch 26. In one embodiment, the first planetary gear set 11 has a step pinion to force the first sun gear 14 to turn backwards at the same speed as the first ring gear 13 when the first planet carrier 12 is grounded. In other embodiments, a compound gear set with a 2:1 R/S ratio or combining two simple planetary gear sets is used to obtain the requires speed ratio. Synchronous shifts between adjacent modes is achievable if the speed ratios of the first-and-fourth mode gear set 31, the second-and-third mode gear set 32, and the high mode gear set 33 are properly selected to match the output of the variator combined with the first planetary gear set 11.

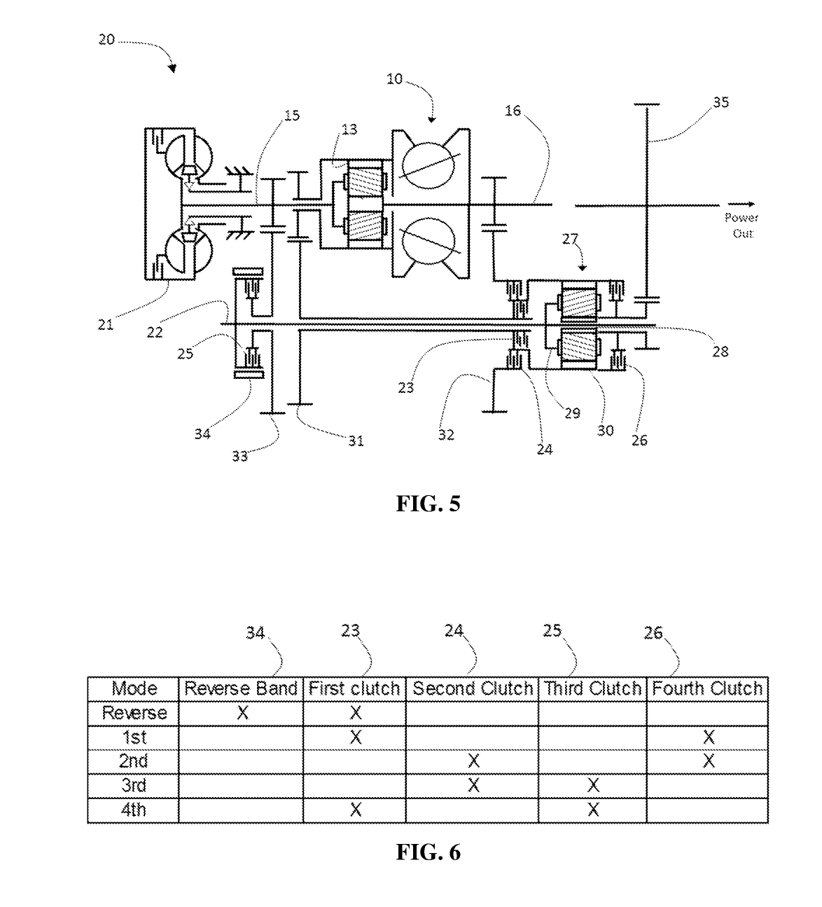

Turning now to FIG. 6, during operation of the CVT 20, the reverse band 34, the first clutch 23, the second clutch 24, the third clutch 25, and the fourth clutch 25 are selectively engaged to thereby provide four forward modes of operation and one reverse mode of operation. The table of FIG. 6 is an illustrative example of a shift schedule for the clutches that is optionally employed for operation of the CVT 20. The rows of the table represent the operating modes, the columns of the table include the clutches or gear. An “X” denotes engagement of the clutch. In some embodiments, the method includes engaging the reverse band and the first clutch to operate in a reverse mode. For example, engaging the first clutch and the fourth clutch operates the CVT 20 in a first mode. Engaging the second clutch and the fourth clutch to operates the CVT 20 in a second mode. Engaging the second clutch and the third clutch to operates the CVT 20 in a third mode. Engaging the first clutch and the third clutch to operates the CVT 20 in a fourth mode.

Provided herein is a continuously variable transmission comprising: a first rotatable shaft operably coupleable to a source of rotational power; a second rotatable shaft aligned substantially coaxial to the first rotatable shaft, the first rotatable shaft and second rotatable shaft forming a main axis of the transmission; a third rotatable shaft aligned substantially parallel to the main axis; a variator assembly having a first traction ring and a second traction ring in contact with a plurality of traction planets, each traction planet having a tiltable axis of rotation; wherein the variator assembly is coaxial with the main axis; a first planetary gearset having a first planet carrier, a first sun gear, and a first ring gear; wherein the first sun gear is coupled to the first traction ring, the first ring gear is coupled to the second traction ring, and the first planet carrier coupled to the first rotatable shaft; a second planetary gear set operably coupled to the third rotatable shaft, the second planetary gear set having a second planet carrier, a second sun gear, and a second ring gear; a first clutch positioned coaxial with the third rotatable shaft; a second clutch coupled to the first clutch, the second clutch coaxial with the third rotatable shaft; a third clutch coaxial with the third rotatable shaft; and a fourth clutch operably coupled to the second planetary gear set.

In some embodiments of the continuously variable transmission, a first-and-fourth mode gear set is operably coupled to the first clutch.

In some embodiments of the continuously variable transmission, a second-and-third mode gear set is operably coupled to the second clutch.

In some embodiments of the continuously variable transmission, the first-and-fourth mode gear set is operably coupled to the first ring gear.

In some embodiments of the continuously variable transmission, the second-and-third mode gear set is operably coupled to the second rotatable shaft.

In some embodiments of the continuously variable transmission, the first clutch is configured to selectively engage the second ring gear.

In some embodiments of the continuously variable transmission, the second clutch is configured to selectively engage the second ring gear.

In some embodiments of the continuously variable transmission, the fourth clutch is operably coupled to the second sun gear and the second ring gear.

In some embodiments of the continuously variable transmission, the second planet carrier is coupled to the third rotatable shaft.

In some embodiments of the continuously variable transmission, a reverse band is operably coupled to the third clutch.

In some embodiments of the continuously variable transmission, a high mode gear set is operably coupled to the third clutch.

In some embodiments of the continuously variable transmission, a torque converter is operably coupled to the first rotatable shaft.

In some embodiments of the continuously variable transmission, a final drive gear is coupled to the second sun gear.

Provided herein is a method comprising providing a continuously variable transmission of any configuration described herein.

Provided herein is a method comprising providing a vehicle driveline comprising a continuously variable transmission of any configuration described herein.

Provided herein is a method comprising providing a vehicle comprising a continuously variable transmission of any configuration described herein.

Provided herein is a continuously variable transmission comprising: a first rotatable shaft operably coupleable to a source of rotational power; a second rotatable shaft aligned substantially coaxial to the first rotatable shaft, the first rotatable shaft and second rotatable shaft forming a main axis of the transmission; a third rotatable shaft aligned substantially parallel to the main axis; a variator assembly having a first traction ring and a second traction ring in contact with a plurality of traction planets, each traction planet having a tiltable axis of rotation; wherein the variator assembly is coaxial with the main axis; a first planetary gearset having a first planet carrier, a first sun gear, and a first ring gear; wherein the first sun gear is coupled to the first traction ring, the first ring gear is coupled to the second traction ring, and the first planet carrier coupled to the first rotatable shaft; a second planetary gear set operably coupled to the third rotatable shaft, the second planetary gear set having a second planet carrier, a second sun gear, and a second ring gear; wherein the second ring gear is operably, and selectively, coupled to the second rotatable shaft; and wherein the second planet carrier is coupled to the third rotatable shaft.

In some embodiments of the continuously variable transmission, a first clutch is positioned coaxial with the third rotatable shaft; and a second clutch is coupled to the first clutch, the second clutch coaxial with the third rotatable shaft.

In some embodiments of the continuously variable transmission, a third clutch is coaxial with the third rotatable shaft; and a fourth clutch is operably coupled to the second planetary gear set.

In some embodiments of the continuously variable transmission, a first-and-fourth mode gear set is coupled to the first clutch.

In some embodiments of the continuously variable transmission, a second-and-third mode gear set is coupled to the second clutch.

In some embodiments of the continuously variable transmission, a high mode gear set is coupled to the third clutch.

In some embodiments of the continuously variable transmission, a final drive gear is coupled to the second sun gear.

Provided herein is a method comprising providing a continuously variable transmission of any configuration described herein.

Provided herein is a method comprising providing a vehicle driveline comprising a continuously variable transmission of any configuration described herein.

Provided herein is a method comprising providing a vehicle comprising a continuously variable transmission of any configuration described herein.

In some embodiments, the method includes engaging the reverse band and the first clutch to operate in a reverse mode.

In some embodiments, the method includes engaging the first clutch and the fourth clutch to operate in a first mode.

In some embodiments, the method includes engaging the second clutch and the fourth clutch to operate in a second mode.

In some embodiments, the method includes engaging the second clutch and the third clutch to operate in a third mode.

In some embodiments, the method includes engaging the first clutch and the third clutch to operate in a fourth mode.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except, in so far as any one claim makes a specified dimension, or range of thereof, a feature of the claim.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein are optionally employed in practicing the invention. It is intended that the following claims define the scope of the invention and that methods and structures within the scope of these claims and their equivalents be covered thereby.

What is claimed is:

1. A continuously variable transmission comprising:
a first rotatable shaft operably coupleable to a source of rotational power;
a second rotatable shaft aligned substantially coaxial to the first rotatable shaft, the first rotatable shaft and second rotatable shaft forming a main axis of the transmission;
a third rotatable shaft aligned substantially parallel to the main axis;
a variator assembly having a first traction ring and a second traction ring in contact with a plurality of traction planets, each traction planet having a tiltable axis of rotation;
wherein the variator assembly is coaxial with the main axis;
a first planetary gearset having a first planet carrier, a first sun gear, and a first ring gear;
wherein the first sun gear is coupled to the first traction ring, the first ring gear is coupled to the second traction ring, and the first planet carrier is coupled to the first rotatable shaft;
a second planetary gear set operably coupled to the third rotatable shaft, the second planetary gear set having a second planet carrier, a second sun gear, and a second ring gear;
a first clutch positioned coaxial with the third rotatable shaft;
a second clutch coupled to the first clutch, the second clutch coaxial with the third rotatable shaft;
a third clutch coaxial with the third rotatable shaft; and
a fourth clutch operably coupled to the second planetary gear set.

2. The continuously variable transmission of claim 1, further comprising a first-and-fourth mode gear set operably coupled to the first clutch.

3. The continuously variable transmission of claim 2, further comprising a second-and-third mode gear set operably coupled to the second clutch.

4. The continuously variable transmission of claim 3, wherein the first-and-fourth mode gear set is operably coupled to the first ring gear.

5. The continuously variable transmission of claim 4, wherein the second-and-third mode gear set is operably coupled to the second rotatable shaft.

6. The continuously variable transmission of claim 5, wherein the first clutch is configured to selectively engage the second ring gear.

7. The continuously variable transmission of claim 6, wherein the second clutch is configured to selectively engage the second ring gear.

8. The continuously variable transmission of claim 7, wherein the fourth clutch is operably coupled to the second sun gear and the second ring gear.

9. The continuously variable transmission of claim 8, wherein the second planet carrier is coupled to the third rotatable shaft.

10. The continuously variable transmission of claim 9, further comprising a reverse band operably coupled to the third clutch.

11. The continuously variable transmission of claim 10, further comprising a high mode gear set operably coupled to the third clutch.

12. The continuously variable transmission of claim 11, further comprising a torque converter operably coupled to the first rotatable shaft.

13. The continuously variable transmission of claim 12, further comprising a final drive gear coupled to the second sun gear.

14. A continuously variable transmission comprising:
a first rotatable shaft operably coupleable to a source of rotational power;
a second rotatable shaft aligned substantially coaxial to the first rotatable shaft, the first rotatable shaft and second rotatable shaft forming a main axis of the transmission;
a third rotatable shaft aligned substantially parallel to the main axis;
a variator assembly having a first traction ring and a second traction ring in contact with a plurality of traction planets, each traction planet having a tiltable axis of rotation;
wherein the variator assembly is coaxial with the main axis;
a first planetary gearset having a first planet carrier, a first sun gear, and a first ring gear;
wherein the first sun gear is coupled to the first traction ring, the first ring gear is coupled to the second traction ring, and the first planet carrier coupled to the first rotatable shaft;
a second planetary gear set operably coupled to the third rotatable shaft, the second planetary gear set having a second planet carrier, a second sun gear, and a second ring gear;
wherein the second ring gear is operably, and selectively, coupled to the second rotatable shaft; and
wherein the second planet carrier is coupled to the third rotatable shaft.

15. The continuously variable transmission of claim 14, further comprising:
a first clutch positioned coaxial with the third rotatable shaft; and
a second clutch coupled to the first clutch, the second clutch coaxial with the third rotatable shaft.

16. The continuously variable transmission of claim 15, further comprising:
a third clutch coaxial with the third rotatable shaft; and
a fourth clutch operably coupled to the second planetary gear set.

17. The continuously variable transmission of claim 16, further comprising a first-and-fourth mode gear set coupled to the first clutch.

18. The continuously variable transmission of claim 17, further comprising a second-and-third mode gear set coupled to the second clutch.

19. The continuously variable transmission of claim 18, further comprising a high mode gear set coupled to the third clutch.

20. The continuously variable transmission of claim 19, further comprising a final drive gear coupled to the second sun gear.
